(19) United States
(12) Patent Application Publication
(10) Pub. No.: US 2017/0176829 A1
(43) Pub. Date: Jun. 22, 2017

(54) LIQUID CRYSTAL DISPLAY APPARATUS

(71) Applicant: Samsung Display Co., Ltd., Yongin-si (KR)

(72) Inventors: Ocksoo Son, Yongin-si (KR); Sungin Ro, Yongin-si (KR); Seunghyun Park, Yongin-si (KR); Youngjin Park, Yongin-si (KR); Jaehak Lee, Yongin-si (KR)

(21) Appl. No.: 15/227,266

(22) Filed: Aug. 3, 2016

(30) Foreign Application Priority Data
Dec. 16, 2015 (KR) 10-2015-0180188

(51) Int. Cl. G02F 1/1362; G02F 1/1333; G02F 1/1343; G02F 1/1337; G02F 1/1368; G02F 1/133; G02F 1/1335

(52) U.S. Cl. CPC G02F 1/136286; G02F 1/13306; G02F 1/133345; G02F 1/133514; G02F 1/133512; G02F 1/133553; G02F 1/1337; G02F 1/1368; G02F 1/134336; G02F 1/13439; G02F 2201/123; G02F 2201/121

(57) ABSTRACT

A liquid crystal display apparatus includes data lines extending in a first direction, gate lines extending in a second direction crossing the first direction, and pixels respectively connected to the data lines and the gate lines, each of the pixels including a liquid crystal layer, in which the first direction is parallel to an initial orientation direction of the liquid crystal layer.

### CROSS-REFERENCE TO RELATED APPLICATION

This application claims priority from and the benefit of Korean Patent Application No. 10-2015-0180188, filed on Dec. 16, 2015, which is hereby incorporated by reference for all purposes as if fully set forth herein.

### BACKGROUND

Field

Exemplary embodiments relate to liquid crystal display apparatuses. More particularly, exemplary embodiments relate to liquid crystal display apparatuses having reduced light leakage and disclination.

Discussion of the Background

As various electronic devices, such as, mobile phones, personal data assistants (PDAs), computers, and large TVs have been developed, demand for flat panel display apparatuses for electronic devices has gradually increased. Among flat panel display apparatuses, liquid crystal display (LCD) apparatuses have advantages over other display apparatuses in that LCD apparatuses have low power consumption, easily display a motion picture, and have a high contrast ratio.

An LCD apparatus includes a liquid crystal layer between two display sheets, and displays an image by controlling incident light to be transmitted or blocked by each pixel by changing the polarizing direction of the incident light through changing the arrangement direction of liquid crystal molecules in the liquid crystal layer, by applying an electric field to the liquid crystal layer.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments include liquid crystal display apparatuses having data lines inclined at a constant direction.

Additional aspects will be set forth in part in the description which follows, and, in part, will be apparent from the disclosure, or may be learned by practice of the inventive concept.

According to an exemplary embodiment of the present invention, a liquid crystal display apparatus includes data lines extending in a first direction, gate lines extending in a second direction crossing the first direction, and pixels respectively connected to the data lines and the gate lines, each of the pixels including a liquid crystal layer, in which the first direction is parallel to an initial orientation direction of the liquid crystal layer.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a schematic plan view of a liquid crystal display apparatus according to an exemplary embodiment of the present invention.

FIG. 2 is a cross-sectional view of a pixel of the liquid crystal display apparatus of FIG. 1.

FIG. 3 is a drawing showing an arrangement relationship between lines and pixels, according to an exemplary embodiment of the present invention.

FIG. 4 is a drawing showing an RGBW arrangement of the pixels of FIG. 3.

FIG. 5 is a drawing showing an arrangement relationship between lines and pixels, according to an exemplary embodiment of the present invention.

FIG. 6 is a drawing showing an arrangement relationship between lines and pixels, according to an exemplary embodiment of the present invention.

FIG. 7 is a drawing showing an arrangement relationship between lines and pixels, according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

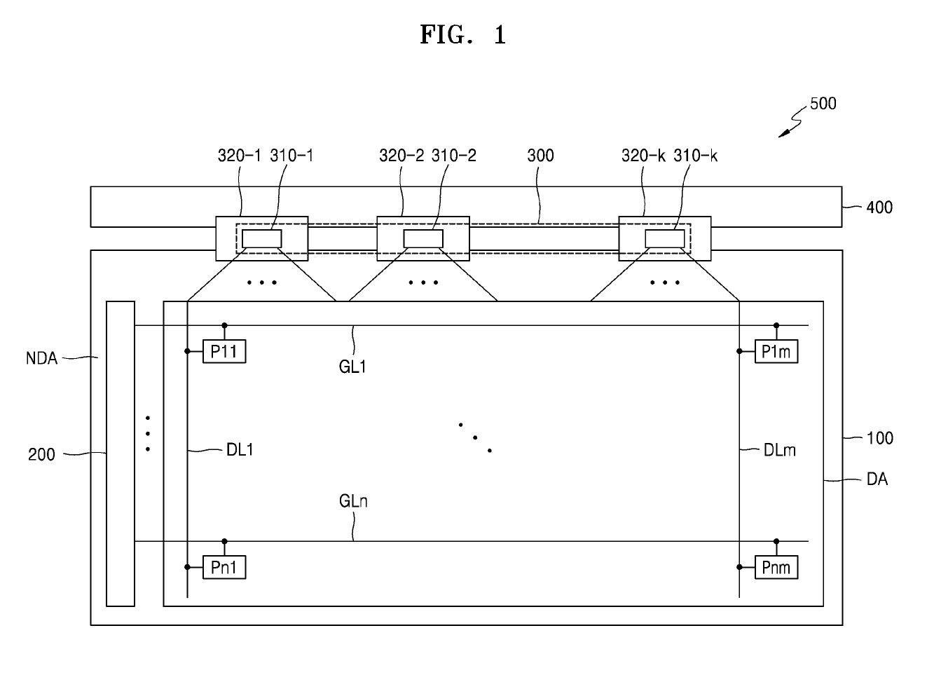

FIG. 1 is a schematic plan view of a liquid crystal display apparatus 500 according to an exemplary embodiment of the present invention.

Referring to FIG. 1, the liquid crystal display apparatus 500 includes a display panel 100, a gate driver 200, a data driver 300, and a driving circuit substrate 400. The display panel 100 includes pixels P11 through Pnm, gate lines GL1 through GLn, and data lines DL1 through DLm. The display panel 100 includes a display region DA and a non-display region NDA.

The pixels P11 through Pnm are arranged in the display region DA in a matrix form. For example, the pixels P11 through Pnm may be disposed in “n” rows and “m” columns crossing each other, in which “m” and “n” are integers greater than 0.

The gate lines GL1 through GLn and the data lines DL1 through DLm cross each other, and are insulated from each other. The gate lines GL1 through GLn are connected to the gate driver 200 to receive gate signals from the gate driver 200. The data lines DL1 through DLm are connected to the data driver 300 to receive analog-type data voltages from the data driver 300.

The pixels P11 through Pnm are connected to corresponding gate lines GL1 through GLn, and to corresponding to the data lines DL1 through DLm, respectively. The pixels P11 through Pnm receive data voltages through corresponding data lines DL1 through DLm, respectively, in response to gate signals transmitted through the gate lines GL1 through GLn. The pixels P11 through Pnm may display a grayscale corresponding to the data voltages.

The gate driver 200 generates gate signals, in response to gate control signals transmitted from a timing controller (not shown) mounted on the driving circuit substrate 400, and may provide the gate signals to the pixels P11 through Pnm in sequence row-by-row through the gate lines GL1 through GLn.

The gate driver 200 may be disposed on the non-display region NDA adjacent to the display region DA. Although FIG. 1 illustrates that the gate driver 200 is disposed on the left side of the display region DA, the gate driver 200 may be alternatively disposed on the non-display region NDA on the right side or on both sides of the display region DA.

The gate driver 200 may include gate driving chips (not shown). The gate driving chips may be mounted on the non-display region NDA adjacent to the left side of the display region DA by using a chip on glass (COG) method. The gate driving chips may be alternatively connected to the non-display region NDA adjacent to the display region DA by using a tape carrier package (TCP) method.

The data driver 300 receives image signals and data control signals from the timing controller (not shown). The data driver 300 generates analog data voltages corresponding to the image signals in response to the data control signals. The data driver 300 provides the analog data voltages to the pixels P11 through Pnm through the data lines DL1 through DLm.

The data driver 300 may include source driving chips 310_1 through 310_k, in which “k” is an integer greater than 0 and less than m. The source driving chips 310_1 through 310_k are respectively mounted on flexible circuit substrates 320_1 through 320_k, and are connected to the non-display region NDA adjacent to the display region DA through the driving circuit substrate 400. Although FIG. 1 illustrates that the data driver 300 is connected to the non-display region NDA adjacent to an upper side of the display region DA, the data driver 300 may be alternatively connected to the non-display region NDA adjacent to a lower side or both sides of the display region DA through the driving circuit substrate 400.

The data driver 300 may be connected to the display panel 100 by using a TCP method. Alternatively, the source driving chips 310_1 through 310_k may be mounted on the non-display region NDA adjacent to the upper side of the display region DA by using a COG method.

Although not shown, the data lines DL1 through DLm may be respectively connected to the source driving chips 310_1 through 310_k through pad electrodes (not shown) on the non-display region NDA. The gate lines GL1 through GLn may be respectively connected to the gate driver 200 through the pad electrodes (not shown) on the non-display region NDA.

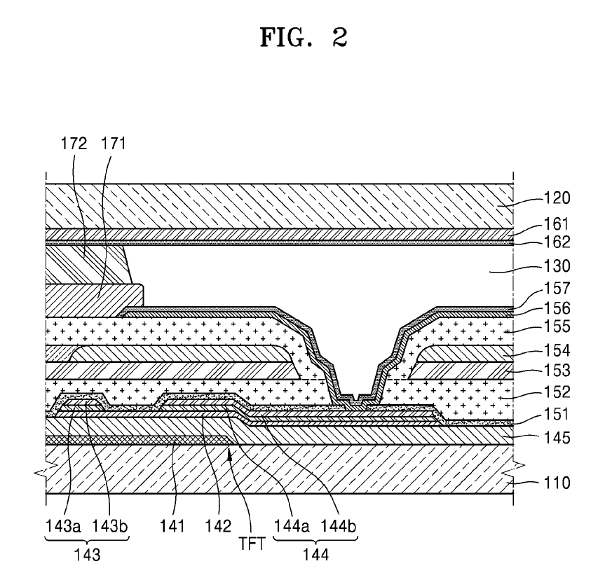

FIG. 2 is a cross-sectional view of a pixel of the liquid crystal display apparatus 500 of FIG. 1. Referring to FIG. 2, the liquid crystal display apparatus 500 may include a first substrate 110, a second substrate 120 facing the first substrate 110, and a liquid crystal layer 130 disposed between the first and second substrates 110 and 120.

The first substrate 110 may be an insulating substrate formed of, for example, glass or plastic. A buffer layer (not shown) may further be disposed on the first substrate 110. The buffer layer has a structure, in which an organic material, an inorganic material, or organic and inorganic material are alternately stacked. The buffer layer may facilitate crystallization of a semiconductor, by preventing diffusion of moisture or impurities generated from the first substrate 110, or by controlling a velocity of heat transfer when a semiconductor active layer is crystallized while simultaneously blocking moisture or impurities.

A thin-film transistor TFT is disposed on a region of an upper surface of the first substrate 110. The thin-film transistor TFT may include a gate electrode 141, an active layer 142 disposed on the gate electrode 141, and a first electrode 143 and a second electrode 144 spaced apart from each other and disposed on the active layer 142. According to the present exemplary embodiment, the first electrode 143 and the second electrode 144 may be a source electrode and a drain electrode, respectively.

A gate insulating film 145 may be disposed between the gate electrode 141 and the active layer 142. According to the present exemplary embodiment, the active layer 142 may include amorphous silicon, and the gate insulating film 145 may be a monolayer or a multiple layer including an inorganic material. For example, the gate insulating film 145 may be a monolayer including silicon nitride (SiNₓ).

The first and second electrodes 143 and 144 may be conductive and disposed on the active layer 142. The first and second electrodes 143 and 144 may respectively include lower layers 143a and 144a and upper layers 143b and 144b disposed on the lower layers 143a and 144a. The active layer 142 may include a region between the first electrode 143 and the second electrode 144 that are spaced apart from each other, and may function as a channel that electrically connects or disconnects the first electrode 143 and the second electrode 144 to each other.

According to the present exemplary embodiment, the lower layers 143a and 144a of the first and second electrodes 143 and 144 may include amorphous silicon, which may be conductive by doping the amorphous silicon with a dopant, for example, n+ amorphous silicon. The lower layers 143a and 144a of the first and second electrodes 143 and 144 may be ohmic contact layers, which may reduce a work function difference between the active layer 142 and the upper layers 143b and 144b, by being disposed between the active layer 142 and the upper layers 143b and 144b. The first and second electrodes 143 and 144 may directly contact the active layer 142, respectively. More particularly, the active layer 142 and the lower layers 143a and 144a may directly contact each other, and the lower layers 143a and 144a and the upper layers 143b and 144b may directly contact each other.

The upper layers 143b and 144b of the first and second electrodes 143 and 144 may include a metal layer, which may include at least one of molybdenum (Mo), aluminum (Al), copper (Cu), and titanium (Ti). The upper layers 143b and 144b may alternatively be a double layer of Ti/Cu, or a triple layer of Ti/Cu/Ti.

The gate electrode 141 may be a region protruded from the gate line GLn, and may receive a gate signal from the gate line GLn. The first electrode 143 may be a region protruded from the data line DLm, and may receive a data signal from the data line DLm. The second electrode 144 is spaced apart from the first electrode 143 with the active layer 142 including a semiconductor material disposed therebetween, and may receive a data signal from the first electrode 143 when a turn-on signal is applied to the gate electrode 141.

A passivation layer 151 is disposed on the data lines DLm through DLm+1, the source electrode 143, and the second electrode 144 of the thin-film transistor TFT spaced apart from the source electrode 143 by a gap, above the first substrate 110. The passivation layer 151 may include a first hole that exposes a portion of the drain electrode 144 of the thin-film transistor TFT.

A first organic layer 152 is disposed on the thin-film transistor TFT. The first organic layer 152 is disposed on the passivation layer 151. The first organic layer 152 exposes a portion of the drain electrode 144 of the thin-film transistor TFT, and includes a second hole corresponding to the first hole of the passivation layer 151. The first organic layer 152 may include a photosensitive organic material.

A reflective layer 153 is disposed on the first organic layer 152. The reflective layer 153 contacts the drain electrode 144 of the thin-film transistor TFT, which is exposed through the first hole of the passivation layer 151 and the second hole of the first organic layer 152. The reflective layer 153 may include a metal having high reflectance, for example, Ag of Ag—Mo (AMO).

A color filter 154 may be disposed on the reflective layer 153. The color filter 154 includes a third hole corresponding to the first and second holes, and a portion of the drain electrode 144 of the thin-film transistor TFT is exposed through the first through third holes.

The color filter 154 may convert incident light to a specific color. For example, the color filter 154 may be one of a red color filter, a green color filter, and a blue color filter that respectively converts incident light to red light, green light, and blue light. The color filter 154 may include an organic material, which may include a pigment or a dye of a color to be converted from incident light. The red color filter, the green color filter, and the blue color filter may be sequentially arranged in a length direction of the data lines DL1 through DLm and the gate lines GL1 through GLn. The arrangement order of the red color filter, the green color filter, and the blue color filter may be varied. When the pixel is a white pixel, the white pixel may be a region that reflects incident light, and thus, a filter that converts the incident light may be omitted.

A second organic layer 155 may be disposed on the first organic layer 152, and cover the reflective layer 153 and the color filter 154. The second organic layer 155 may include a fourth hole that exposes a portion of the drain electrode 144 of the thin-film transistor TFT, and corresponds to the second hole of the first organic layer 152. The second organic layer 155 may include a photosensitive organic material.

A pixel electrode 156 is disposed on the color filter 154, and is electrically connected to the thin-film transistor TFT through the first through third holes. The pixel electrode 156 may include a transparent and conductive material, for example, indium tin oxide (ITO) or indium zinc oxide (IZO).

A first orientation film 157 may be disposed on the pixel electrode 156. The first orientation film 157 may be disposed between the first substrate 110 and the liquid crystal layer 130. The first orientation film 157 may include an inorganic material, such as silicon oxide (SiO₂), or an organic material, such as polyimide. A rubbing pattern may be included in a surface of the first orientation film 157. The rubbing pattern may determine an initial orientation direction of the liquid crystal layer 130 that contacts the first orientation film 157. More particularly, the direction of liquid crystal molecules of the liquid crystal layer 130 may be determined according to the orientation pattern of the first orientation film 157 that contacts the liquid crystal layer 130.

The second substrate 120 faces the first substrate 110, and a common electrode 161 may be disposed on the second substrate 120 and contact each other. The common electrode 161 may include, for example, ITO or IZO.

A second orientation film 162 may be disposed on the common electrode 161. More particularly, the second orientation film 162 may be disposed between the second substrate 120 and the liquid crystal layer 130. The second orientation film 162 may include an inorganic material or an organic material. The inorganic material may be SiO₂, and the organic material may be polyimide. A rubbing pattern may be included in a surface of the second orientation film 162. The rubbing pattern may determine an initial orientation direction of the liquid crystal layer 130 that contacts the second orientation film 162.

The liquid crystal layer 130 is disposed between the first substrate 110 and the second substrate 120, and includes liquid crystal molecules (not shown). The liquid crystal molecules of the liquid crystal layer 130 may display an image by a liquid crystal electrical field applied thereto. The arrangement of the electrodes and the orientation direction of the liquid crystal molecules may vary, depending on a mode of the liquid crystal display apparatus 500. The liquid crystal display apparatus 500 according to the present exemplary embodiment may be in a twisted nematic (TN) mode, however, the liquid crystal display apparatus 500 may alternatively be in an in plane switching (IPS) mode, a fringe field switching (FFS) mode, or a vertical alignment (VA) mode.

A black matrix 171 may be disposed between the first substrate 110 and the second substrate 120 to prevent color mix between the pixels. The black matrix 171 may be disposed over the first substrate 110, and cover the data lines DL1 through DLm and the gate lines GL1 through GLn. The black matrix 171 has a lattice shape having an opening, and a cross-section of a pixel may be determined by the opening. A spacer 172 is disposed between the first substrate 110 and the second substrate 120 facing the first substrate 110, and maintains a gap therebetween. The spacer 172 may be disposed on a location where the black matrix 171 is disposed between the pixels.

When light enters the liquid crystal display apparatus 500, the light is output to the outside through the liquid crystal layer 130, after being reflected by the reflective layer 153. When light transmits through the liquid crystal layer 130, the transmittance of the light is controlled to realize an image. As such, the liquid crystal display apparatus 500 of FIG. 2 may be referred to as a reflection-type liquid crystal display apparatus.

Since layers are stacked on the first substrate 110 or the second substrate 120 of the liquid crystal display apparatus 500, a step difference may occur in the pixels or between the pixels. In particular, when the liquid crystal display apparatus 500 is a reflection-type liquid crystal display apparatus, the liquid crystal display apparatus 500 may include the reflective layer 153 and the color filter 154, and thus, the step difference may occur in greater degrees. The step difference may cause a rubbing fault in a rubbing process for the orientation of liquid crystal molecules, which may cause light leakage, and thus, may reduce color reproducibility.

In the liquid crystal display apparatus 500 according to the present exemplary embodiment, in order to prevent the rubbing fault, a length direction Dd of the data lines DL1 through DLm may be disposed parallel to an initial orientation direction of the liquid crystal layer 130. As used herein, “an initial orientation direction” may be referred to an orientation direction of at least a portion of the liquid crystal molecules included in the liquid crystal layer 130, when an electric field is not applied to the liquid crystal layer 130. In addition, “parallel” may be referred to being not only mathematically and completely parallel, but also being substantially parallel within an error range.

When the liquid crystal display apparatus 500 is in a TN mode, the orientation direction of liquid crystal molecules may be changed along a distance between the first substrate 110 towards the second substrate 120. As such, the initial orientation direction in the TN mode may be referred to an initial orientation direction of a portion of the liquid crystal layer 130 adjacent to the first substrate 110, on which the data lines DL1 through DLm are disposed. When the liquid crystal display apparatus 500 is in a VA mode, the initial orientation direction may be referred to an average orientation direction of all liquid crystal molecules or an initial orientation direction of a portion of the liquid crystal layer 130 adjacent to the first substrate 110, on which the data lines DL1 through DLm are disposed. Hereinafter, for convenience of description, the initial orientation direction of the liquid crystal layer 130 will be described as the average orientation direction of liquid crystal molecules adjacent to the first substrate 110 on which the data lines DL1 through DLm are disposed, when an electric field is not applied to the liquid crystal layer 130, in order to avoid obscuring exemplary embodiments described herein.

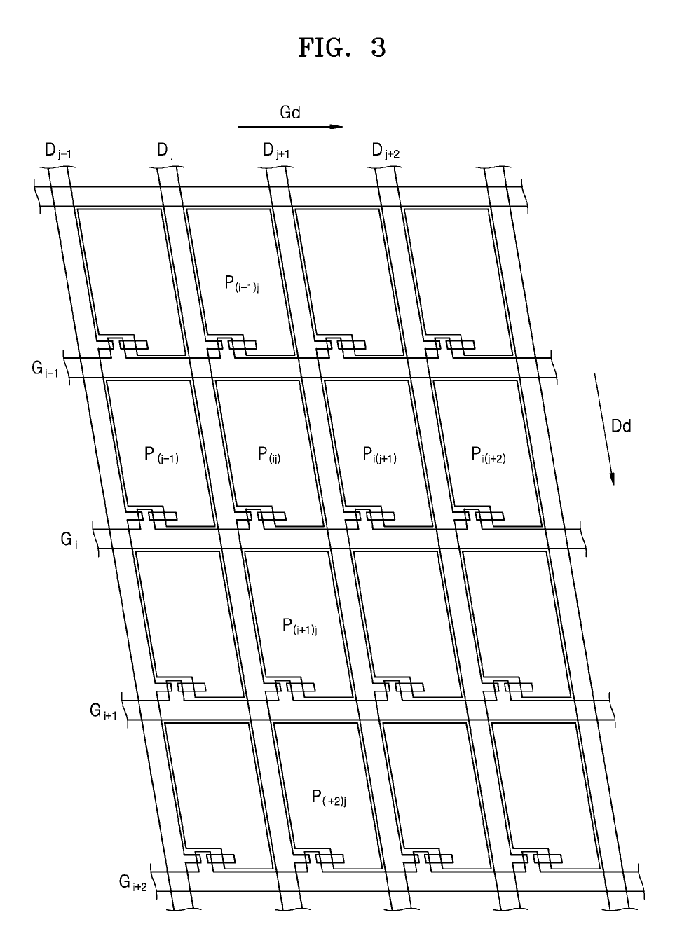

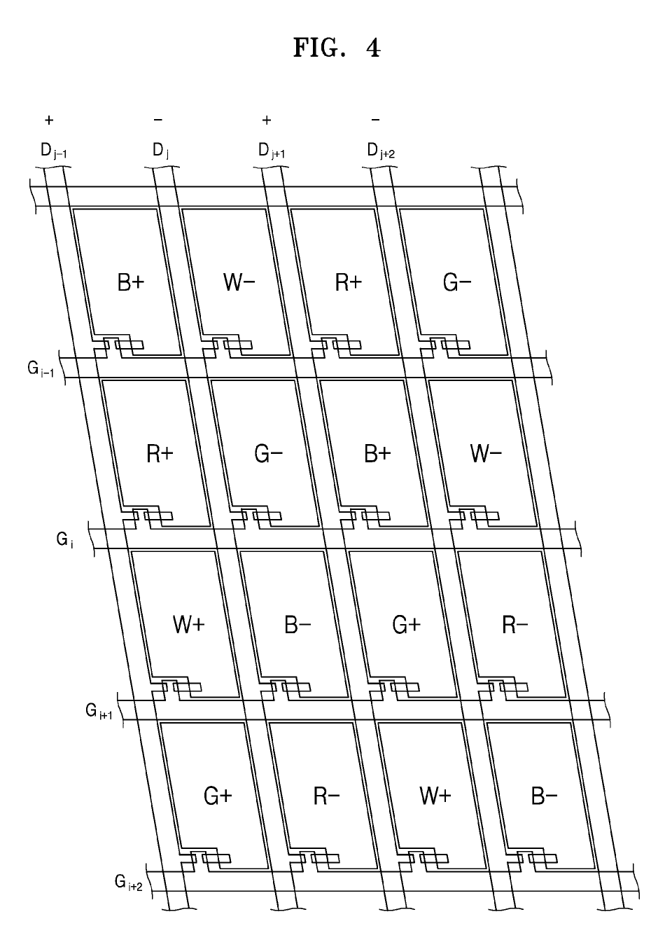

FIG. 3 is a drawing showing an arrangement relationship between the lines and the pixels, according to an exemplary embodiment of the present invention. FIG. 4 is a drawing showing an RGBW arrangement of the pixels of FIG. 3.

Referring to FIGS. 3 and 4, a liquid crystal display apparatus may include data lines extending in a first direction, gate lines extending in a second direction crossing the first direction, and pixels respectively connected to the data lines and the gate lines and respectively including the liquid crystal layer 130. In the pixels, the data lines may be arranged to be parallel to the initial orientation direction of the liquid crystal layer 130. More particularly, the first direction may be parallel to the initial orientation direction of the liquid crystal layer 130. Here, the first direction may be referred to as a length direction Dd of the data lines, and the second direction may be referred to as a length direction Gd of the gate lines.

Generally, an initial orientation direction of the liquid crystal layer 130 may be inclined to a certain degree with respect to the length direction Gd. As such, the length direction Dd of the data lines according to exemplary embodiments of the present invention may be disposed to be inclined with a certain degree with respect to the length direction Gd of the gate lines. For example, if a liquid crystal display apparatus is in a mixed twisted nematic (MTN) mode, the length direction Dd of the data lines may be disposed to be inclined with an inclination angle in a range from 50 degrees to 85 degrees with respect to the length direction Gd of the gate lines. As used herein, the inclination angle may be referred to as an acute angle of angles between the length direction Dd of the data lines and the length direction Gd of the gate lines.

Pixels may be divided by the data lines and the gate lines. The pixels that emit lights of color different from each other may be sequentially arranged in the length direction Gd of the gate lines. For example, first through fourth pixels Pi(j−1), Pij, Pi(j+1), and Pi(j+2) that emit light of different colors may be arranged in the length direction Gd of the gate lines. For example, as illustrated in FIG. 4, the first pixel Pi(j−1) may be a red pixel R that emits red light, the second pixel P(ij) may be a green pixel G that emits green light, the third pixel Pi(j+1) may be a blue pixel B that emits blue light, and the fourth pixel Pi(j+2) may be a white pixel W that transmits incident light without converting the incident light.

As illustrated in FIG. 3, the first through fourth pixels Pi(j−1), P(ij), Pi(j+1), and Pi(j+2) may be sequentially arranged in the length direction Gd of the gate lines. For example, an i^{th} gate line Gi may apply a gate signal to the sequentially arranged first through fourth pixels Pi(j−1), Pij, Pi(j+1), and Pi(j+2).

In the liquid crystal display apparatus according to an exemplary embodiment of the present invention, the data line may apply a data signal to the first through fourth pixels Pi(j−1), Pij, Pi(j+1), and Pi(j+2). Among the data lines, a j^{th} data line Dj may apply a data signal to sequentially arranged a fifth P(i−1)j, the second pixel Pij, a sixth pixel P(i+1)j, and a seventh pixel P(i+2)j. A portion of a region of the sixth pixel P(i+1)j may overlap a portion of a region of the fourth pixel Pi(j+2) in a perpendicular direction to the length direction Gd of the gate lines. For example, as illustrated in FIG. 4, the fifth pixel P(i−1)j may be a white pixel W that emits white light, the sixth pixel P(i+1)j may be a blue pixel B that emits blue light, and the seventh pixel P(i+2)j may be a red pixel R that emits red light.

Cross-sections of the pixels may have a polygonal shape inclined to a certain direction. For example, a first side of the cross-section of the pixels may be parallel to the length direction Gd of the gate lines, a second side that contacts the first side may be parallel to the length direction Dd of the data lines. The shape of the cross-sections of the pixels may include a parallelogram shape. Cross-sections of a pixel electrode and a filter included in the pixel may have an inclined shape corresponding to the cross-section of the pixel, or a cross-section of the opening of the black matrix may be the same as that of the pixel.

The data lines may alternately apply data signals having polarities different from each other to the pixels by a unit of a data line. For example, when an j−1^{th} data line Dj−1 and a j+1^{th} data line Dj+1 apply a positive “+” data signal to the pixels, a j^{th} data line Dj and a j+2^{th} data line Dj+2 may apply a negative “−” data signal to the pixels.

Among the pixels that emit the same color light based on a data line, adjacent pixels may be driven by data signals having different polarities from each other. For example, as illustrated in FIG. 4, a data signal applied to a red pixel R+ that is driven by the j−1^{th} data line D(j−1) may have a different polarity than a data signal applied to a red pixel R− that is driven by the j^{th} data line Dj. In this manner, when driving polarities of pixels that emit the same color light based on a data line are different, an occurrence of mono-color flicker may be reduced.

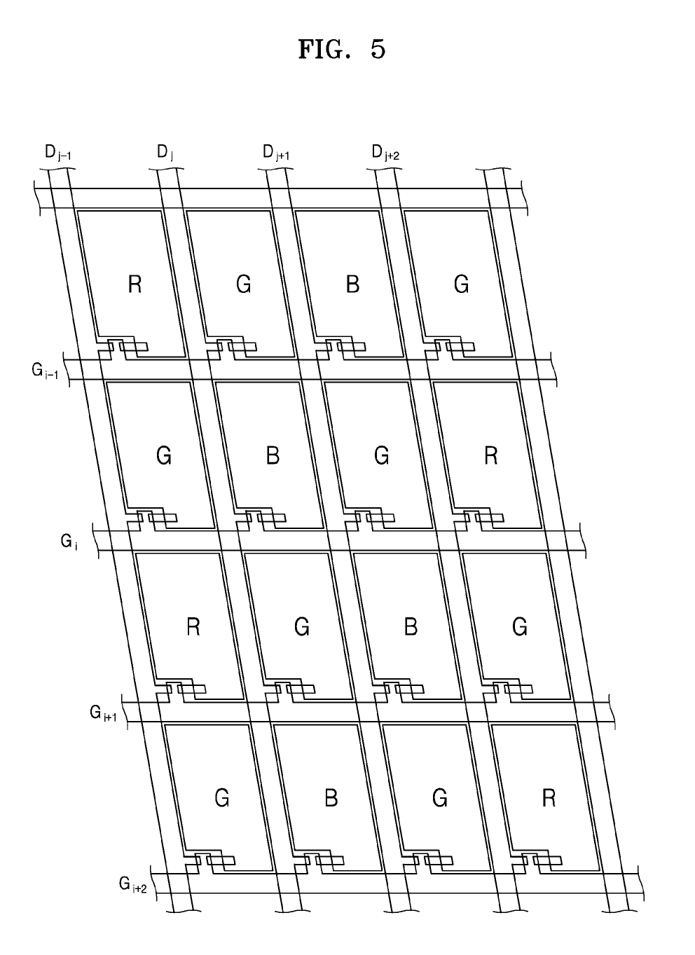

FIG. 5 is a drawing showing an arrangement relationship between lines and pixels, according to an exemplary embodiment of the present invention. The pixels of FIG. 5, as compared to the pixel illustrated with reference to FIG. 4, may be configured of a red pixel R, a green pixel G, and a blue pixel B, and may not include a white pixel W configured to transmit incident light, as the incident light is without color conversion.

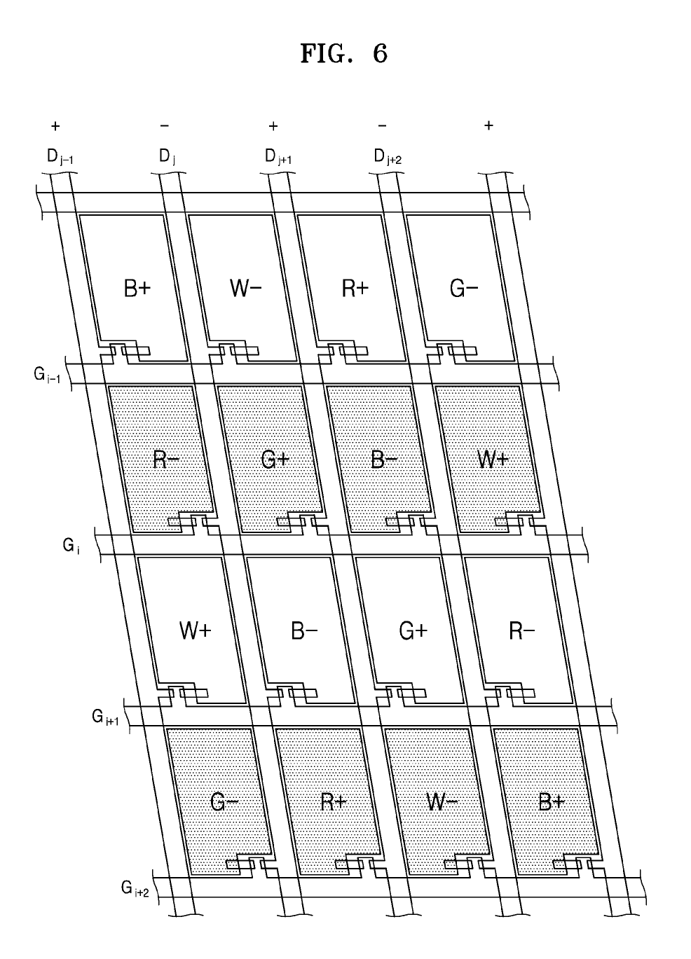

FIG. 6 is a drawing showing an arrangement relationship between lines and pixels, according to an exemplary embodiment of the present invention. The data lines may alternately apply data signals having different polarities from each other to the pixels by a unit of a data line. For example, when the j−1^{th} data line D(j−1) and the j+1^{th} data line D(j+1) apply a positive “+” data signal to the pixels, the j^{th} data line Dj and the j+2^{th} data line D(j+2) may apply a negative “−” data signal to the pixels. More particularly, the j^{th} data line Dj may apply a data signal to a white pixel “W−” located on (i−1)j and a blue pixel “B−” located on (i+1)j, and the j+1^{th} data line D(j+1) neighboring the j^{th} data line Dj may apply a data signal to a green pixel “G+” located on ij and a red pixel “R+” located on (i+2)j. In this case, a center pixel and adjacent pixel surrounding the center pixel may be applied with data signals having different polarities from each other. In this manner, although a parasitic capacitance may be generated due to misalignment between the pixels, since the variation in the parasite capacity may not be substantially changed, the amount of variation in kick-back may be substantially the same. Accordingly, the generation of a partial residual image may be reduced.

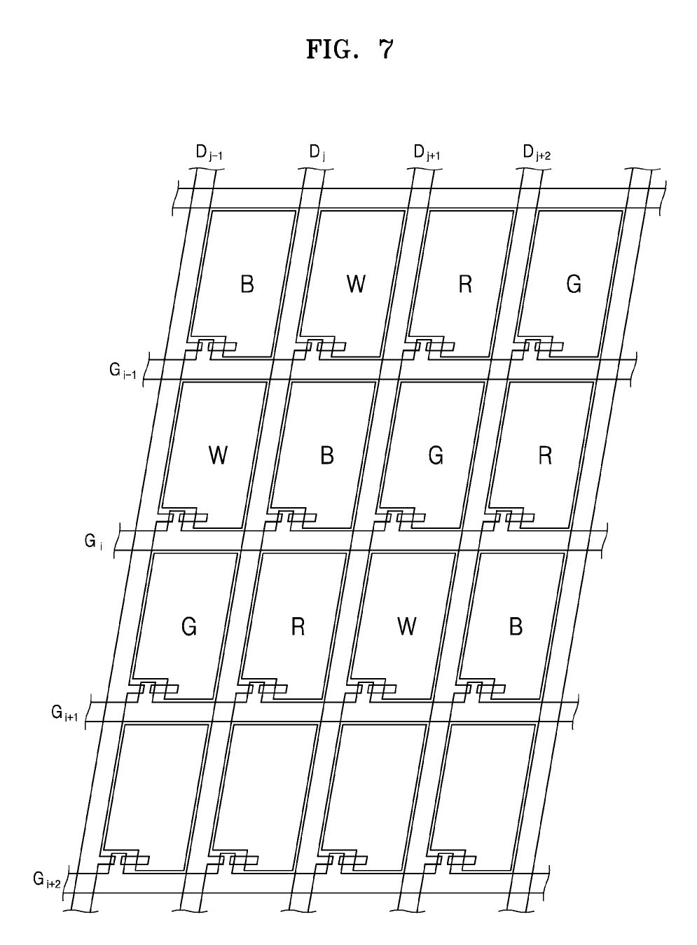

FIG. 7 is a drawing showing an arrangement relationship between lines and pixels, according to an exemplary embodiment of the present invention. When FIG. 4 is compared with FIG. 7, the length direction Dd of the data lines of FIG. 7 may be an opposite direction to the length direction Dd of the data lines of FIG. 4. The length direction Dd of the data lines of FIG. 7 may be parallel to the initial orientation direction of the liquid crystal layer 130 included in the pixels. More particularly, the initial orientation direction of the liquid crystal layer 130 in FIG. 7 may be opposite to the initial orientation direction of the liquid crystal layer 130 in FIG. 4.

It is contemplated that while data lines and an initial orientation direction of the liquid crystal layer 130 of the liquid crystal display apparatus 500 having a reflective type have been described above, however, the liquid crystal display apparatus 500 may also be applied to a transmission-type liquid crystal display apparatus.

In the liquid crystal display apparatus according to exemplary embodiments, since data lines are arranged corresponding to various rubbing directions of liquid crystals, light leakage due to mismatch between liquid crystal molecules and data lines may be reduced. Also, since the data lines are arranged corresponding to rubbing directions, generation disclination of the liquid crystal molecules may be reduced.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A liquid crystal display apparatus, comprising:
data lines extending in a first direction;
gate lines extending in a second direction crossing the first direction; and
pixels respectively connected to the data lines and the gate lines, each of the pixels comprising a liquid crystal layer,
wherein the first direction is parallel to an initial orientation direction of the liquid crystal layer.

2. The liquid crystal display apparatus of claim 1, wherein the pixels comprise first, second, and third pixels sequentially disposed in the first direction.

3. The liquid crystal display apparatus of claim 2, wherein liquid crystal layers of the first, second, and third pixels have the same initial orientation direction.

4. The liquid crystal display apparatus of claim 2, wherein each of the first, second, and third pixels are configured to emit light of one of a red color, green color, and blue color.

5. The liquid crystal display apparatus of claim 2, wherein a first data line of the data lines is configured to apply a data signal to the first, second, and third pixels.

6. The liquid crystal display apparatus of claim 2, wherein:
a first data line of the data lines is configured to apply a data signal to the first pixel; and
a second data line adjacent to the first data line is configured to apply a data signal to the second pixel.

7. The liquid crystal display apparatus of claim 2, wherein a fourth pixel, the first pixel, and a fifth pixel of the pixels are sequentially disposed in the second direction.

8. The liquid crystal display apparatus of claim 7, wherein the first pixel, the fourth pixel, and the fifth pixel are configured to emit light of a red color, green color, and blue color, respectively.

9. The liquid crystal display apparatus of claim 7, wherein the second pixel is configured to emit light having the same color as light configured to be emitted from one of the fourth pixel and the fifth pixel.

10. The liquid crystal display apparatus of claim 7, wherein a portion of the second pixel overlaps one of the fourth pixel and the fifth pixel in a direction perpendicular to the second direction.

11. The liquid crystal display apparatus of claim 1, wherein the initial orientation direction is inclined at a constant angle with respect to the second direction.

12. The liquid crystal display apparatus of claim 11, wherein the constant angle is in a range of 50 degrees to 85 degrees.

13. The liquid crystal display apparatus of claim 1, wherein the initial orientation direction is an orientation direction of liquid crystal molecules in the liquid crystal layer, when an electric field is not applied to the liquid crystal layer.

14. The liquid crystal display apparatus of claim 1, wherein the initial orientation direction is determined by a rubbing pattern of an orientation film disposed in the pixels.

15. The liquid crystal display apparatus of claim 14, further comprising a substrate comprising the data lines,
wherein the orientation film is disposed between the substrate and the liquid crystal layer.

16. The liquid crystal display apparatus of claim 1, wherein a shape of at least one of the pixels is inclined towards the first direction.

17. The liquid crystal display apparatus of claim 16, wherein:
a first side of the at least one of the pixels is parallel to a length direction of the data lines; and
a second side that contacts the first side of the at least one of the pixels is parallel to a length direction of second lines.

18. The liquid crystal display apparatus of claim 16, wherein the at least one of the pixels has a parallelogram shape.

19. The liquid crystal display apparatus of claim 1, wherein at least one of the pixels comprises a reflective layer configured to reflect incident light.

20. The liquid crystal display apparatus of claim 19, further comprising a substrate comprising the data lines,
wherein the reflective layer is disposed between the substrate and the liquid crystal layer.
